(19) United States
(12) Patent Application Publication
(10) Pub. No.: US 2018/0038291 A1
(43) Pub. Date: Feb. 8, 2018

(54) THROTTLE VALVE ASSEMBLY

(71) Applicant: Ford Global Technologies, LLC, Dearborn, MI (US)

(72) Inventor: William Gerald Barr, Chelmsford (GB)

(21) Appl. No.: 15/655,226

(22) Filed: Jul. 20, 2017

(30) Foreign Application Priority Data
Aug. 4, 2016 (GB) 1613441.3

(51) Int. Cl. F02D 9/14

(52) U.S. Cl. CPC F02D 9/14; F02D 2009/0228

(57) ABSTRACT

A throttle valve assembly provided. The throttle valve assembly includes a wedge shaped valve member slidingly mounted within a throttle body defining offset inlet and outlet passages. The wedge shaped valve member is moveable towards and away from the inlet passage by an actuator mechanism to vary the air flow area in a throttle passage of the throttle valve assembly.

### CROSS REFERENCE TO RELATED APPLICATION

The present application claims priority to Great Britain Application No. 1613441.3, filed on Aug. 4, 2016. The entire contents of the above-referenced application are hereby incorporated by reference in its entirety for all purposes.

### FIELD

The present description relates generally to the control of air flow into an internal combustion engine and in particular to a throttle valve assembly for controlling air flow into an internal combustion engine.

### BACKGROUND/SUMMARY

Butterfly type valve are used to control the flow of air in previous internal combustion engines. It will be appreciated that the term ‘air’ as meant herein includes not only atmospheric air admitted via an air inlet but also other gas flows to the engine such as, for example, recirculated exhaust gas and crankcase ventilation gas.

It is a problem with such a butterfly arrangement that when the butterfly valve is in a partially open position considerable downstream turbulence is produced which has an adverse effect on engine efficiency. Even at wide open throttle there will be a pressure drop and turbulence from the throttle plate of a butterfly type valve.

To at least partially address the aforementioned problems the inventors developed a throttle valve assembly. In one example, the throttle valve assembly includes a throttle body defining offset inlet and outlet air flow passages connected via a throttle passage providing an adjustable air flow area, a wedge shaped valve member slidingly mounted in the throttle body to vary the air flow area of the throttle passage and an actuator mechanism to move the wedge shaped valve member towards and away from the inlet air flow passage to vary the air flow area of the throttle passage wherein the inlet air flow passage extends along a first longitudinal axis, the outlet air flow passage extends along a second longitudinal axis arranged parallel to but offset from the first longitudinal axis and the actuator mechanism is operable to slide the wedge shaped valve member between open throttle and closed throttle positions along a third longitudinal axis arranged parallel to the first and second longitudinal axes. The throttle valve assembly having the structural features described above decreases the amount of turbulence generated by the throttle when compared to previous throttle designs such as butterfly valves. As a result, the efficiency of the throttle valve assembly and engine are correspondingly increased.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram showing a motor vehicle having an engine air induction control system that includes a throttle valve assembly;

FIG. 2 is a diagrammatic cut-away side view of a throttle valve assembly showing a wedge shape valve member in a throttle closed position; and

FIG. 3 is a diagrammatic cut-away side view similar to FIG. 2, but showing the wedge shape valve member in a wide open throttle position.

### DETAILED DESCRIPTION

A throttle valve assembly is described herein that achieves the objective of increased valve efficiency. In one example, a throttle valve assembly is provided. The throttle valve assembly includes a throttle body defining offset inlet and outlet air flow passages connected via a throttle passage providing an adjustable air flow area, a wedge shaped valve member slidingly mounted in the throttle body to vary the air flow area of the throttle passage and an actuator mechanism to move the wedge shaped valve member towards and away from the inlet air flow passage to vary the air flow area of the throttle passage wherein the inlet air flow passage extends along a first longitudinal axis, the outlet air flow passage extends along a second longitudinal axis arranged parallel to but offset from the first longitudinal axis and the actuator mechanism is operable to slide the wedge shaped valve member between open throttle and closed throttle positions along a third longitudinal axis arranged parallel to the first and second longitudinal axes. Providing a throttle valve with the wedge shaped valve member and a valve inlet that is offset from a valve outlet enables the turbulence generated by the valve in an open position to be reduced. Consequently, valve efficiency and correspondingly engine efficiency may be increased in comparison to previous butterfly type throttle valves.

Moving the wedge shaped valve member towards the inlet passage may reduce the air flow area of the throttle passage and moving the wedge shaped valve member away from the inlet passage may increase the air flow area of the throttle passage.

The inlet air flow passage may be defined by an inlet portion of an upper wall of the throttle body, a lower wall of the throttle body and two side walls of the throttle body, the outlet air flow passage may be defined by an outlet portion of the upper wall of the throttle body, an outlet lower wall of the throttle body and the two side walls of the throttle body and the throttle passage may be defined by a transition portion of the upper wall of the throttle body, an inclined face of the wedge shaped valve member and the two side walls of the throttle body.

The inclined face of the wedge shaped valve member may face towards the inlet air flow passage.

The transition portion of the upper wall may be inclined with respect to the inlet and outlet portions of the throttle body and the inclined face of the wedge shaped valve member may be arranged substantially parallel to the transition portion of the upper wall of the throttle body.

The actuator mechanism may include an electric motor driving a threaded shaft engaged with a threaded member fastened to the wedge shaped valve member.

In another aspect, an engine air induction control system for a motor vehicle is provided. The engine air induction control system may include an air inlet flow path to an engine including a throttle valve assembly, an electronic controller, an accelerator pedal position sensor associated with an accelerator pedal of the motor vehicle to provide a driver torque demand input to the electronic controller and an electronically controllable actuator forming part of the actuator mechanism of the throttle valve assembly operably connected to the electronic controller.

The electronic controller may be arranged to operate the electronically controllable actuator to move the wedge shaped valve member of the throttle valve assembly based upon the input from the accelerator pedal position sensor.

The electronic controller may be operable to use the electronically controllable actuator to move the wedge shaped valve member of the throttle valve assembly to increase the air flow area in the throttle passage of the throttle body assembly from the current air flow area if the input from the accelerator pedal position sensor indicates a request for increased engine torque.

The electronic controller may be operable to use the electronically controllable actuator to move the wedge shaped valve member of the throttle valve assembly to reduce the air flow area in the throttle passage of the throttle body assembly from the current air flow area if the input from the accelerator pedal position sensor indicates a request for reduced engine torque.

In another aspect, a motor vehicle is provided with an internal combustion engine and an engine air induction control system that includes the aforementioned engine air induction control system.

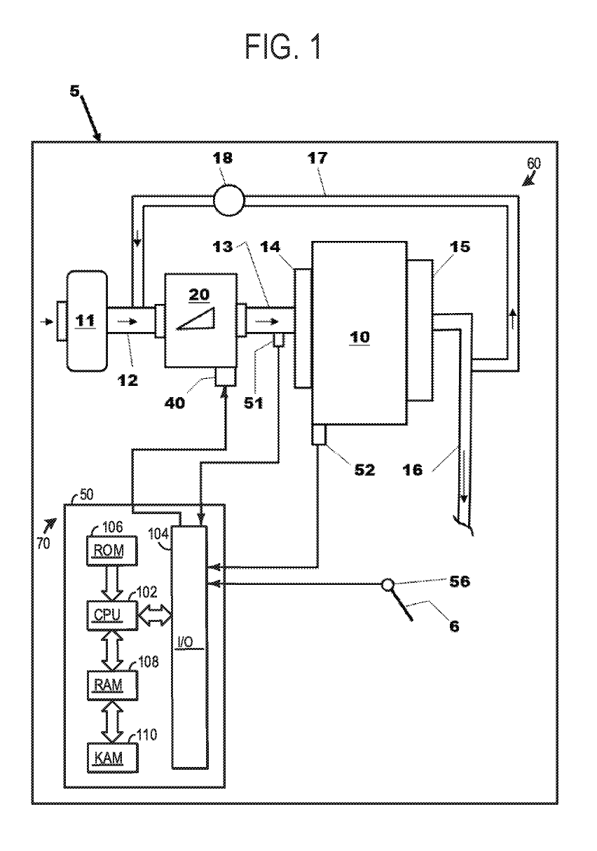

With reference to FIG. 1 there is shown a motor vehicle 5 having an engine 10 (e.g., direct injection gasoline engine). Air is supplied to the engine 10 via an air inlet manifold 14 and exhaust gasses flow out from the engine to atmosphere via an exhaust manifold 15 and an exhaust pipe 16. It will be appreciated that one or more emission control devices (not shown) may be included in the flow path of the exhaust gas from the engine 10 to atmosphere.

Atmospheric air enters a first induction duct 12 via an air filter 11 and flows through an air flow passage forming part of a throttle valve assembly 20 to a second induction duct 13 which is connected to the inlet manifold 14 of the engine 10.

An exhaust gas recirculation system 60 may be included in the vehicle 5. The exhaust gas recirculation system 60 may include an exhaust gas recirculation pipe 17 connect at one end to the exhaust pipe 16 and connected at an opposite end to the first induction duct 12. An exhaust gas recirculation valve 18 is used to control the flow of exhaust gas through the exhaust gas recirculation pipe 17. It will be appreciated that in practice the exhaust gas may flow through an intercooler, in one example, before flowing back to the first induction duct 12. Therefore, the engine described herein is not limited to a normally aspirated engine having exhaust gas recirculation of the type shown.

The throttle valve assembly 20 forms part of an engine air induction control system 70 that also includes an electronic controller 50 and a number of sensors of which only a mass air flow sensor 51, an engine speed sensor 52, and an accelerator pedal position sensor 56 associated with an accelerator pedal 6 are shown in FIG. 1.

It will be appreciated that in practice the electronic controller 50 may normally also control the flow of fuel to the engine 10 and that the fuel supply system has been omitted from FIG. 1. However, it will be appreciated that in other examples a fuel supply system including a fuel tank, one or more fuel pumps, a fuel rail, a fuel injector, etc., may be provided in the vehicle 5.

Although not shown in FIG. 1, the electronic controller 50 is also connected to the exhaust gas recirculation valve 18 to control the flow of exhaust gas flowing through the exhaust gas recirculation pipe 17.

The throttle valve assembly 20 includes an electronically controlled actuator in the form of an electric motor 40 that is controlled by the electronic controller 50. It will be appreciated that the electronic controller may in practice not directly control the electric motor 40 but rather control a power controller used to control the electric motor 40, in one example. Thus, the power controller may act as an actuator, in such an example. Specifically, the electric motor 40 may be of a servo motor type having feedback, in some examples, but a micro-stepping motor could alternatively be used, in other examples.

FIG. 1 also shows the controller 50 as a conventional microcomputer including: microprocessor unit 102, input/output ports 104, read-only memory 106, random access memory 108, keep alive memory 110, and a conventional data bus. Controller 50 is configured to receive various signals from sensors coupled to the engine 10. The sensors may include the mass air flow sensor 51, engine speed sensor 52, accelerator pedal position sensor 56, engine coolant temperature sensor (not shown), exhaust gas sensors (not shown), etc. Therefore in one example, the controller 50 may be configured to receive throttle position (TP) from the accelerator pedal position sensor 56 coupled to the pedal 6 and actuated by a vehicle operator. Therefore, the controller 50 receives signals from the various sensors.

Furthermore, the controller 50 may employ various actuators to adjust engine operation based on the received signals and instructions stored in memory (e.g., non-transitory memory) of the controller. Thus, it will be appreciated that the controller 50 may send and receive signals from the throttle valve assembly 20. Specifically in one example, the controller 50 may send control signals to the electric motor 40 to trigger movement of flow control components in the throttle valve assembly 20, discussed in greater detail herein. The controller 50 may also send control signals to the exhaust gas recirculation valve 18 as well as other suitable actuators in the engine.

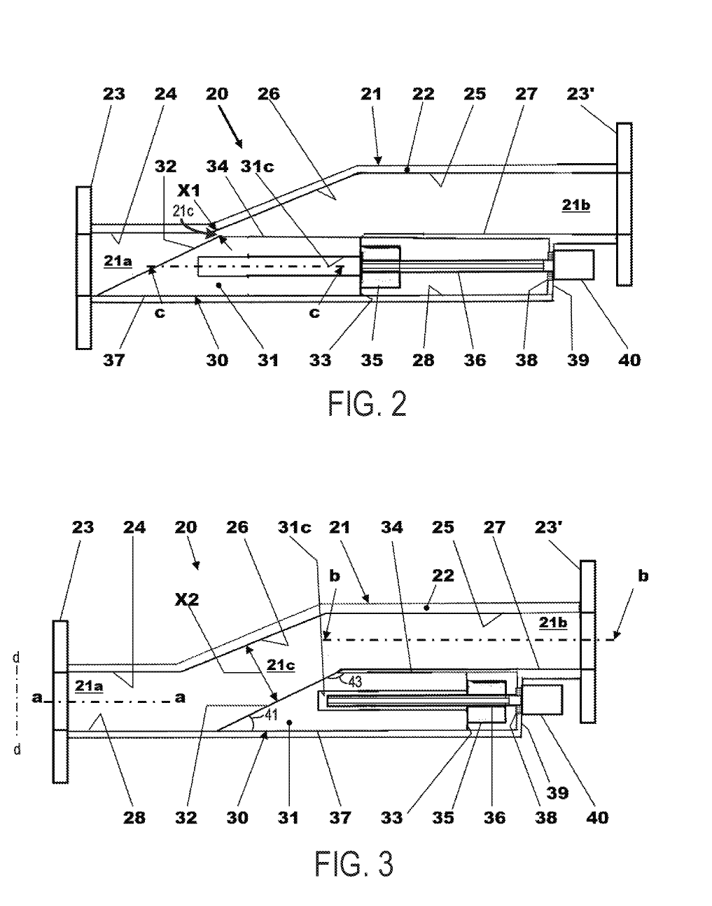

With particular reference to FIGS. 2 and 3, the throttle valve assembly 20 includes a throttle body 21 in which is slidingly mounted a wedge shaped valve member 30 the position of which is adjustable by the electric motor 40 via an actuator linkage including a threaded member 35 and a threaded drive shaft 36 threadingly engaged with the threaded member 35 and driveably connected to the electric motor 40. The electric motor 40, threaded member 35 and threaded shaft 36 (e.g., threaded drive shaft) form in combination an electronically controllable actuator mechanism.

The wedge shaped valve member 30 has a valve body 31 having an inclined face 32 (e.g., inclined front face), an upper face 34, a lower face 37 and two side faces (not shown). The wedge shaped valve member 30 is slidingly mounted within the throttle body 21.

The throttle body 21 includes an upper wall 22 that has an inlet portion 24, an outlet portion 25 and a linking or transition portion 26, an outlet lower wall 27, a lower wall 28, a linking or intermediate wall 39 joining the outlet lower wall 27 to the lower wall 28 and two side walls (not shown).

A first flange 23 is fastened to an inlet end of the throttle body 21 for use in attaching the throttle body 21 to the first induction duct 12, shown in FIG. 1, and a second flange 23′ is fastened to an outlet end of the throttle body 21 for use in connecting the throttle body 21 to the second induction duct 13, shown in FIG. 1.

A quadrilateral shaped inlet air flow passage 21a is formed at the inlet end of the throttle body 21 by the inlet portion 24 of the upper wall 22, the lower wall 28 and the two side walls (not shown). In the case of this example the inlet passage 21a is rectangular in shape having a width ‘W’ that is greater than its height. However in other examples, the inlet passage may have a curved shape (e.g., circular or oval cross-section).

A quadrilateral shaped outlet air flow passage 21b is formed at the outlet end of the throttle body 21 by the outlet portion 25 of the upper wall 22, the outlet lower wall 27 and the two side walls (not shown). In the case of this example the outlet passage 21b is rectangular in shape having a width ‘W’ that is greater than its height. It will be appreciated that the width and height dimensions of the outlet passage 21b are substantially the same as the corresponding dimensions of the inlet passage 21a. However in other examples, the height and/or width dimensions of the inlet passage 21a and the outlet passage 21b may not be equivalent.

The outlet passage 21b is offset with respect to the inlet passage 21a so that a staggered or zigzag flow passage is defined by the throttle body 21 between the inlet passage 21a and the outlet passage 21b. The inlet passage 21a extends along a first longitudinal axis a-a and the outlet passage 21b extends along a second longitudinal axis b-b arranged parallel to but offset from the first longitudinal axis a-a. A radial axis d-d is also provided for reference in FIG. 3. It will be appreciated that the inlet passage 21a and the outlet passage 21b are also offset with regard to radial axis d-d. Offsetting the inlet and outlet passages in this way enables the turbulence in the throttle assembly to be decreased when the assembly is in an open position. As a result, the efficiency of the throttle valve is increased when compared to butterfly type throttle valves.

A throttle passage 21c (indicated in FIG. 3) is defined between the transition portion 26 of the upper wall, the two side walls of the throttle body 21 and the inclined face 32 of the wedge shaped valve member 30.

When the wedge shaped valve member 30 is in a closed throttle position shown in FIG. 2, the height X1 of the throttle passage 21c is defined between the transition portion 26 of the upper wall 22 and the inclined face 32 of the valve body 31 in the region where the inclined face 32 of the valve body 31 overlaps with the transition portion 26 of the upper wall. When the valve body 31 is so positioned an air flow area of (X1×W) is produced. ‘W’ being the width of the throttle passage 21c.

When the valve member 31 is in a wide open throttle position shown in FIG. 3, the height X2 of the throttle passage 21c is defined between the linking portion 26 of the upper wall 22 and the inclined face 32 of the valve body 31. When the valve body 31 is so positioned an air flow area of (X2×W) is produced. ‘W’ being, as before, the width of the throttle passage 21c. Therefore the air flow area is related to the distance between the inclined face 32 of the valve body 31 and the inner face of the transition portion 26 of the upper wall 22. It will be appreciated that the width ‘W’ of the throttle passage 21c remains constant irrespective of the position of the valve body 31 because it is defined by the fixed side walls of the throttle body 21.

The inclined face 32 of the valve body 31 faces towards the inlet passage 21a and is arranged at an angle 41 (e.g., acute angle) with respect to the lower face 37 of the valve body 31. The inclined face 32 is also arranged at an angle 43 (e.g., obtuse angle) with respect to the upper face 34 of the valve body 31. The upper and lower faces 34 and 37 of the valve body 31 are arranged substantially parallel to one another. The inclined face 32 of the valve body 31 is arranged at a predefined angle that orientates the inclined face 32 substantially parallel to the facing inner surface of the transition portion 26 of the upper wall 22. The lower face 37 of the valve body 31 is arranged to slidingly rest upon the lower wall 28 of the throttle body 21 so as to facilitate sliding motion of the valve body 31 along a third longitudinal axis c-c. The actuator mechanism 35, 36, 40 is operable, when needed, to slide the wedge shaped valve member 30 along the third longitudinal axis c-c that is arranged parallel to the first and second longitudinal axes a-a and b-b. Specifically, in the depicted example, the first longitudinal axis a-a is aligned with the third longitudinal axis c-c. However, in other examples, the first longitudinal axis a-a may be offset from the third longitudinal axis c-c.

The valve body 31 also has a rear face 33 to which is fastened the threaded member 35. The threaded member 35 defines a clearance passage 31c to allow for the passage of the threaded drive shaft 36. It will be appreciated that the width of the valve body 31 may be substantially the same as the interior width ‘W’ of the throttle body 21 in the region where the valve body 31 may be located so that a clearance fit is produced between the valve body 31 and the throttle body 21.

The upper face 34 of the wedge shaped valve member 30 is arranged to co-operate with the outlet lower wall 27 so as to produce a substantially uniform lower surface to the outlet passage 21b irrespective of the position of the wedge shaped valve member 30. The valve body 31 slides under the outlet lower wall 27 when the wedge shaped valve member 30 is in the wide open throttle position and outlet lower wall 27 has a shaped front end to reduce flow disturbances. In the case of this example the shaped front end of the outlet lower wall 27 has a chamfer arranged at substantially the same orientation as the inclined face 32 of the valve member 30.

The linking wall 39 that joins the outlet lower wall 27 to the lower wall 28 has a seal 38 mounted therein to seal the passage of the threaded drive shaft 36 through the linking wall 39.

Operation of the throttle valve assembly may be as follows.

From the closed throttle position shown in FIG. 2, to increase the air flow area of the throttle body 21 and hence the flow rate of air through the throttle body 21 the wedge shaped valve member 30 is moveable away from the inlet passage 21a until it reaches a maximum displaced position called the wide open throttle position, as shown in FIG. 3. The movement of the wedge shaped valve member 30 is effected by the electric motor 40 which rotates the threaded drive shaft 36 which cause the tubular threaded member 35 fastened to the valve body 31 to be drawn towards the linking wall 39. However, other types of actuation linkage for actuating the wedge shaped member have been contemplated.

From the wide open throttle position shown in FIG. 3, to reduce the air flow area through the throttle body 21 and hence the flow rate of air through the throttle body 21 the wedge shaped valve member 30 is moveable towards the inlet passage 21a until it reaches a minimum displaced position called the closed throttle position as shown in FIG. 2. The movement of the wedge shaped valve member 30 is effected by the electric motor 40 which rotates the threaded drive shaft 36 which cause the tubular threaded member 35 fastened to the valve body 31 to be moved away from the linking wall 39.

It will be appreciated that the wedge shaped valve member 30 can be located at any position between the closed and wide open positions depending upon the requirement for air from the engine 10. Movement of the valve body 31 away from the inlet passage 21a is termed ‘movement in a throttle opening direction’ and movement of the valve body 31 towards the inlet passage 21a is termed ‘movement in a throttle closing direction’. When the valve body 31 is moved toward the inlet passage 21a the valve body blocks a greater amount of the throttle passage 21c.

Due to the use of the wedge shaped valve member 30 and the shape of the throttle body 21 no sudden change of direction is needed for the air flowing through the throttle body 21 and so turbulence is considerably reduced compared to a conventional butterfly valve. Furthermore, when in the wide open throttle position the wedge shaped valve member 30 has little or no reducing effect on the air flow area through the throttle body 21 and so does not substantially impede the flow of air through the throttle body 21.

It will be appreciated that the throttle body 21 shown in FIGS. 2 and 3 is conceptual in nature and that in practice there would not be sharp edges where the transitions between the various portions 24, 25, 26 occur they would be in the form of smooth large radius junctions.

Similarly the junction of the inclined and upper faces 32, 34 of the valve member 31 would not be a sharp edge but would have a radius to blend the two surfaces 32, 34.

With particular reference to FIG. 1 operation of the engine air induction control system will now be described.

A demand for torque from the engine 10 is produced when an accelerator pedal such as the accelerator pedal 6 is depressed and the amount of torque demanded by the driver will depend upon the magnitude of depression of the accelerator pedal 6.

Although in some cases there is a linear relationship between the magnitude of accelerator pedal 6 depression and torque demand in other cases the relationship may not be linear. However, irrespective of the relationship, in general terms when a driver depresses the accelerator pedal 6 a demand for torque is produced that increases with increasing depression of the accelerator pedal 6 and this is sensed by the accelerator pedal position sensor 56 and is supplied as a torque demand input to the electronic controller 50.

The electronic controller 50 uses the input from the accelerator pedal position sensor 56 to control the position of the valve member 30 in the throttle body 21 by causing the electric motor 40 to be rotated in a desired direction.

For example, if the demand for torque from the driver increases from a current torque demand then the electronic controller 50 is operable to cause the motor 40 to move the valve member 30 in throttle opening direction, that is to say away from the inlet passage 21a, so as to increase the flow rate of air to the engine 10. It will be appreciated that the amount of fuel supplied to the engine 10 will also be adjusted by the electronic controller 50 to produce a desired air fuel ratio.

Similarly, if the demand for torque from the driver reduces from the current demand then the electronic controller 50 is operable to cause the motor 40 to move the valve member 30 in a throttle closing direction, that is to say towards the inlet passage 21a, to reduce the flow rate of air to the engine 10 and the amount of fuel supplied to the engine 10 will be adjusted by the electronic controller 50 to produce a desired air fuel ratio.

It will be appreciated that the electronic controller 50 may also be operable to vary the position of the wedge shaped valve member 30 and/or the amount of fuel supplied during constant engine running conditions in which the position of the accelerator pedal 6 is not adjusted by the driver in order to maintain a desired air fuel ratio or to control emissions from the engine 10.

When the driver is not depressing the accelerator pedal 6 the controller 50 is operable to move the valve member 30 to the closed throttle position, shown in FIG. 2, and when the driver fully depresses the accelerator pedal 6 the electronic controller 50 is arranged to move the valve member 30 to the wide open throttle position, shown in FIG. 3.

Although the invention has been described with reference to an embodiment using a rotary electric actuator it will be appreciated that other types of actuator could be used such as for example a linear actuator. It will also be appreciated that the actuator could alternatively be an electronically controllable hydraulic actuator or an electronically controllable pneumatic actuator.

It will also be appreciated that the invention is not limited to use on a direct injection gasoline engine and could be used on any engine requiring an electronically controllable throttle valve.

Therefore in summary, the throttle valve assembly described herein reduces the turbulence and pressure drop across the throttle valve compared with a butterfly type throttle valve and produces the following advantages: increased fuel economy; increased maximum torque; increased power; and decreased exhaust emissions, including CO2.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

FIGS. 2-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The invention will further be described in the following paragraphs. In one aspect, a throttle valve assembly is provided. The throttle valve assembly comprises a throttle body defining offset inlet and outlet air flow passages connected via a throttle passage providing an adjustable air flow area; a wedge shaped valve member slidingly mounted in the throttle body to vary the air flow area of the throttle passage; and an actuator mechanism to move the wedge shaped valve member towards and away from the inlet air flow passage to vary the air flow area of the throttle passage; wherein the inlet air flow passage extends along a first longitudinal axis, the outlet air flow passage extends along a second longitudinal axis arranged parallel to but offset from the first longitudinal axis and the actuator mechanism is operable to slide the wedge shaped valve member between open throttle and closed throttle positions along a third longitudinal axis arranged parallel to the first and second longitudinal axes.

In another aspect, an engine air induction control system for a motor vehicle is provided. The engine air induction control system comprises an air inlet flow path to an engine including a throttle valve assembly including; a throttle body defining offset inlet and outlet air flow passages connected via a throttle passage providing an adjustable air flow area; a wedge shaped valve member slidingly mounted in the throttle body to vary the air flow area of the throttle passage; and an actuator mechanism to move the wedge shaped valve member towards and away from the inlet air flow passage to vary the air flow area of the throttle passage; wherein the inlet air flow passage extends along a first longitudinal axis, the outlet air flow passage extends along a second longitudinal axis arranged parallel to but offset from the first longitudinal axis and the actuator mechanism is operable to slide the wedge shaped valve member between open throttle and closed throttle positions along a third longitudinal axis arranged parallel to the first and second longitudinal axes; an electronic controller; an accelerator pedal position sensor associated with an accelerator pedal of the motor vehicle to provide a driver torque demand input to the electronic controller; and an electronically controllable actuator forming part of the actuator mechanism of the throttle valve assembly operably connected to the electronic controller.

In yet another aspect, a throttle valve assembly is provided. The throttle valve assembly comprises a throttle body including radially offset inlet and outlet air flow passages connected via a throttle passage with an adjustable air flow area; a wedge shaped valve member slidingly mounted in the throttle body to vary the air flow area of the throttle passage; and an actuator mechanism moving the wedge shaped valve member towards and away from the inlet air flow passage.

In any of the aspects herein or combinations of the aspects, moving the wedge shaped valve member towards the inlet passage reduces the air flow area of the throttle passage and moving the wedge shaped valve member away from the inlet passage increases the air flow area of the throttle passage.

In any of the aspects herein or combinations of the aspects, the inlet air flow passage may be defined by an inlet portion of an upper wall of the throttle body, a lower wall of the throttle body and two side walls of the throttle body, the outlet air flow passage may be defined by an outlet portion of the upper wall of the throttle body, an outlet lower wall of the throttle body and the two side walls of the throttle body and the throttle passage may be defined by a transition portion of the upper wall of the throttle body, an inclined face of the wedge shaped valve member, and the two side walls of the throttle body.

In any of the aspects herein or combinations of the aspects, the inclined face of the wedge shaped valve member may face toward the inlet air flow passage.

In any of the aspects herein or combinations of the aspects, the transition portion of the upper wall may be inclined with respect to the inlet and outlet portions of the throttle body and the inclined face of the wedge shaped valve member may be arranged substantially parallel to the transition portion of the upper wall of the throttle body.

In any of the aspects herein or combinations of the aspects, the actuator mechanism may comprise an electric motor driving a threaded shaft engaged with a threaded member fastened to the wedge shaped valve member.

In any of the aspects herein or combinations of the aspects, the electronic controller may be arranged to operate the electronically controllable actuator to move the wedge shaped valve member of the throttle valve assembly based upon the input from the accelerator pedal position sensor.

In any of the aspects herein or combinations of the aspects, the electronic controller may be operable to use the electronically controllable actuator to move the wedge shaped valve member of the throttle valve assembly to increase the air flow area in the throttle passage of the throttle body assembly from the current air flow area if the input from the accelerator pedal position sensor indicates a request for increased engine torque.

In any of the aspects herein or combinations of the aspects, the electronic controller may be operable to use the electronically controllable actuator to move the wedge shaped valve member of the throttle valve assembly to reduce the air flow area in the throttle passage of the throttle body assembly from the current air flow area if the input from the accelerator pedal position sensor indicates a request for reduced engine torque.

In any of the aspects herein or combinations of the aspects, the wedge shaped valve member may include an inclined face that intersects a longitudinal axis of the inlet flow passage.

In any of the aspects herein or combinations of the aspects, the throttle body may include a transition portion parallel to the inclined face of the wedge shaped valve member.

In any of the aspects herein or combinations of the aspects, the transition portion may be asymmetric.

In any of the aspects herein or combinations of the aspects, a valve body of the wedge shaped valve member and the inlet air flow passage may share a common longitudinal axis.

In any of the aspects herein or combinations of the aspects, the actuator mechanism may include an actuator linkage coupled to a motor.

In any of the aspects herein or combinations of the aspects, the actuator linkage may include a threaded member and a threaded drive shaft threadingly engaged with the threaded member coupled to the wedge shaped valve member.

In any of the aspects herein or combinations of the aspects, the motor may rotate the threaded drive shaft to move the wedge shaped valve member along a longitudinal axis.

In any of the aspects herein or combinations of the aspects, the wedge shaped valve member may include an inclined face arranged at an acute angle with regard to a lower face.

In any of the aspects herein or combinations of the aspects, the wedge shaped valve member may include an upper face positioned downstream of the inclined face.

It will be appreciated that the configurations and control schemes disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A throttle valve assembly, comprising:
a throttle body defining offset inlet and outlet air flow passages connected via a throttle passage providing an adjustable air flow area;
a wedge shaped valve member slidingly mounted in the throttle body to vary the air flow area of the throttle passage; and
an actuator mechanism to move the wedge shaped valve member towards and away from the inlet air flow passage to vary the air flow area of the throttle passage;
wherein the inlet air flow passage extends along a first longitudinal axis, the outlet air flow passage extends along a second longitudinal axis arranged parallel to but offset from the first longitudinal axis and the actuator mechanism is operable to slide the wedge shaped valve member between open throttle and closed throttle positions along a third longitudinal axis arranged parallel to the first and second longitudinal axes.

2. The throttle valve assembly of claim 1, wherein moving the wedge shaped valve member towards the inlet passage reduces the air flow area of the throttle passage and moving the wedge shaped valve member away from the inlet passage increases the air flow area of the throttle passage.

3. The throttle valve assembly of claim 1, wherein the inlet air flow passage is defined by an inlet portion of an upper wall of the throttle body, a lower wall of the throttle body and two side walls of the throttle body, the outlet air flow passage is defined by an outlet portion of the upper wall of the throttle body, an outlet lower wall of the throttle body and the two side walls of the throttle body and the throttle passage is defined by a transition portion of the upper wall of the throttle body, an inclined face of the wedge shaped valve member and the two side walls of the throttle body.

4. The throttle valve assembly of claim 3, wherein the inclined face of the wedge shaped valve member faces toward the inlet air flow passage.

5. The throttle valve assembly of claim 4, wherein the transition portion of the upper wall is inclined with respect to the inlet and outlet portions of the throttle body and the inclined face of the wedge shaped valve member is arranged substantially parallel to the transition portion of the upper wall of the throttle body.

6. The throttle valve assembly of claim 1, wherein the actuator mechanism comprises an electric motor driving a threaded shaft engaged with a threaded member fastened to the wedge shaped valve member.

7. An engine air induction control system for a motor vehicle, comprising:
an air inlet flow path to an engine including a throttle valve assembly including;
a throttle body defining offset inlet and outlet air flow passages connected via a throttle passage providing an adjustable air flow area;
a wedge shaped valve member slidingly mounted in the throttle body to vary the air flow area of the throttle passage; and
an actuator mechanism to move the wedge shaped valve member towards and away from the inlet air flow passage to vary the air flow area of the throttle passage;
wherein the inlet air flow passage extends along a first longitudinal axis, the outlet air flow passage extends along a second longitudinal axis arranged parallel to but offset from the first longitudinal axis and the actuator mechanism is operable to slide the wedge shaped valve member between open throttle and closed throttle positions along a third longitudinal axis arranged parallel to the first and second longitudinal axes;
an electronic controller;
an accelerator pedal position sensor associated with an accelerator pedal of the motor vehicle to provide a driver torque demand input to the electronic controller; and
an electronically controllable actuator forming part of the actuator mechanism of the throttle valve assembly operably connected to the electronic controller.

8. The engine air induction control system of claim 7, wherein the electronic controller is arranged to operate the electronically controllable actuator to move the wedge shaped valve member of the throttle valve assembly based upon the input from the accelerator pedal position sensor.

9. The engine air induction control system of claim 8, wherein the electronic controller is operable to use the electronically controllable actuator to move the wedge shaped valve member of the throttle valve assembly to increase the air flow area in the throttle passage of the throttle body assembly from the current air flow area if the input from the accelerator pedal position sensor indicates a request for increased engine torque.

10. The engine air induction control system of claim 8, wherein the electronic controller is operable to use the electronically controllable actuator to move the wedge shaped valve member of the throttle valve assembly to reduce the air flow area in the throttle passage of the throttle body assembly from the current air flow area if the input from the accelerator pedal position sensor indicates a request for reduced engine torque.

11. A throttle valve assembly, comprising:
a throttle body including radially offset inlet and outlet air flow passages connected via a throttle passage with an adjustable air flow area;
a wedge shaped valve member slidingly mounted in the throttle body to vary the air flow area of the throttle passage; and
an actuator mechanism moving the wedge shaped valve member towards and away from the inlet air flow passage.

12. The throttle valve assembly of claim 11, where the wedge shaped valve member includes an inclined face that intersects a longitudinal axis of the inlet flow passage.

13. The throttle valve assembly of claim 12, where the throttle body includes a transition portion parallel to the inclined face of the wedge shaped valve member.

14. The throttle valve assembly of claim 12, where the transition portion is asymmetric.

15. The throttle valve assembly of claim 11, where a valve body of the wedge shaped valve member and the inlet air flow passage share a common longitudinal axis.

16. The throttle valve assembly of claim 11, where the actuator mechanism includes an actuator linkage coupled to a motor.

17. The throttle valve assembly of claim 16, where the actuator linkage includes a threaded member and a threaded drive shaft threadingly engaged with the threaded member coupled to the wedge shaped valve member.

18. The throttle valve assembly of claim 17, where the motor rotates the threaded drive shaft to move the wedge shaped valve member along a longitudinal axis.

19. The throttle valve assembly of claim 11, where the wedge shaped valve member includes an inclined face arranged at an acute angle with regard to a lower face.

20. The throttle valve assembly of claim 11, where the wedge shaped valve member includes an upper face positioned downstream of the inclined face.
